(19) United States
(12) Patent Application Publication
(10) Pub. No.: US 2012/0054120 A1
(43) Pub. Date: Mar. 1, 2012

(54) A METHOD AND ARRANGEMENT FOR FEDERATING RATINGS DATA

(76) Inventors: Johan Hjelm, Tokyo (JP); Mattias lidström, Stockholm (SE); Mona Matti, Nacka (SE)

(21) Appl. No.: 13/318,941

(22) PCT Filed: May 19, 2009
(86) PCT No.: PCT/SE2009/050562

§ 371 Date: Nov. 4, 2011

(51) Int. Cl. G06Q 30/02

(52) U.S. Cl. 705/347

(57) ABSTRACT

A method is provided which enables ratings data registered by a number of users for a first service and at least one corresponding service to be collected, wherein each user have been federated for a Single-Sign-On (SSO) on the first service as well as on the corresponding service/s. In response to a request for a set of ratings data received from a user requesting for the first service, a group of users is identified and the SSO identity of each SSO federated user of the identified group of users is mapped to one or more service identities of the respective SSO federated user. The mapping enables ratings data associated with the SSO users of the identified group of SSO users to be collected and normalized, such that the requested ratings data can then be provided to the requesting user in a unified format.

### TECHNICAL FIELD

The present invention relates generally to a method and arrangement for handling user generated ratings and system generated recommendations across different services in a normalized manner.

### BACKGROUND

In a number of situations people today provide ratings of products, such as e.g. a graded personal opinion of videos they have watched, groceries they have bought, music they have listened to, or services, they have used. Such ratings are frequently stored in the system to which they were originally given and accessible via one specific service.

However, such ratings that have been accumulated in a ratings system can be very useful also to other users, which may use services, as well as to the services themselves, which may require information about different user's personal opinions about the respective service. Such services exist today, such as e.g. Epinions (www.epinions.org) and Ratings.net (www.ratings.net).

In the present context the term ratings may refer both to user-generated ratings, i.e. ratings that have been given by one or more users, as well as to predicted ratings, i.e. ratings data that may be used for generating recommendations for a requesting user. Throughout this document, the term “ratings” is therefore to be interpreted in its broadest sense, to include both categories mentioned above.

The problem mentioned above, can be illustrated with the scenario 100 of FIG. 1, showing how a requesting user 1 101, which may be represented by a user device that is used by a physical user, or by a service which is requesting ratings data for a specific processing purpose, may access different services, namely service A 102, service B 103, and service C 104, respectively. Throughout this document the term “service” is to be defined as a web-based service, such as e.g. a hotel booking service, a movie renting service or a news service, that is provided by a SP. Such services will comprise at least one sub-service, which enables a user to rate services, sub-services and/or other items via an accessed service.

In order to access ratings data from the three different services, user 1 does, however, have to execute three different log-in procedures, each of which gives user 1 access to a respective service. Once user 1 has obtained ratings data from a respective service, the ratings data has to be processed separately, before other ratings data can be obtained from another service.

Ratings obtained via some type of rating service are frequently referring to the same products or services, also typically referred to as items or attributes, but they are normally neither consistent in the used ratings format/data type, nor in the rating systems used by the different services. These issues usually do not raise any problem, since ratings collected by a specific user or requestor are generally not shared with other users or between different Service Providers (SPs).

However, enabling users to share ratings data associated with different users and obtained from different services may be desirable in a number of situations, in particular where a requesting user wants to give different ratings depending on whether the receiver or requestor is the provider of the used service or not.

The problem discussed above is similar to the problem of applying a Single Sign On (SSO) system, which is a system for federating log-in information. There are a number of known SSO systems on the market, which enable a user to tie their login identity that is used for accessing one service to the login identities used for accessing other services, thus making it possible to avoid the need of multiple login procedures for accessing different services and instead enables a user to access a plurality of services via one single log in procedure.

Existing SSO systems do not only federate the identity of a user, thereby enabling one login to apply to multiple services, typically provided by different SPs. SSO systems also enable the federation of attributes. However, the fact that attributes may be federated in an SSO system does not imply that attributes of different services that are accessible via one of a plurality of federated services via a single log on are compatible, or can even be used in the same system.

As already mentioned above, user's ratings can apply across different services. This may be particularly desirable, if a user provides recommendations for a specific category of items or attributes in one service, but other recommendations in other services, e.g. for personal integrity reasons.

In current systems, it is most likely that a user may use the service of a specific SP to rate this SP's services in one way, while the same service is given a completely different rate when given to another service of another SP. By way of example a user that dislike the services of the newspaper Aftonbladet, provided by SP 1, may avoid rating these services low when these rates are given to a service of Aftonbladet, but may gladly give low rates for these services via a service of its competitor newspaper Expressen, provided by SP 2.

The problems mentioned above can be exemplified with the following scenario 200, schematically illustrated in FIG. 2. In FIG. 2 a user, user 1 201 logs into service A 202, which is assumed to have an SSO federation with service B 203, service C 204, service D 205, and service E 206. Another user, User 2 207 logs into service B 203, which correspondingly has an SSO federation with services A 202, service C 204, service D 205, and service E 206.

Since all services mentioned above are mutually federated, user 1 may e.g. access service C 204, which provides a location for logged on users to provide ratings of any of the other services A, B, D and E. In this case we assume that user 1 201 wants to rate service D 205. User 1 gives service D 205 one star out of three, since he does not feel he has had a positive experience of this service.

User 2 then access service B 203, where he also rates service D 205. In this case we assume that service D 205 is given 3 butterflies out of 7 from user 2. For a user accessing service E 206, which also is federated with the other services, it would be useful to know how other users have rated service D 205. However, he has no way of knowing how to compare one star, given in service B 203 with three butterflies, which is the data format that was used in service C. This problem would even be compounded if the ratings were instead defined according to a textual description.

A system may be further compounded if automated recommendations, generated from a user's actions, are to be considered. These recommendations can e.g. be the result of logged user actions and derived statistics, which have been fed into a user model, from where a recommendation has then been derived. If a recommendation is e.g. four apples for service D 205, it will be impossible to relate this recommendation to the stars and butterflies, and, thus, even though the different services are accessible via one single sign-on via a SSO mechanism, sharing of ratings provided from different services will not be possible.

Today, there is, thus, no way for ratings and/or recommendations neither to be shared in a generic way, nor to be provided to a user in a compatible format. There is also no method available which enables users to share ratings and/or recommendations under control of the user.

### SUMMARY

The present invention aims to solve, or diminish at least some of the problems mentioned above by providing a method which enables ratings data obtained from different services to be shared by different requesting users in a generic way and which enables the shared ratings data to be provided to the user in a compatible format.

According to one aspect a method of collecting ratings data, registered by a number of users for a first service and at least one corresponding service is provided, wherein these users have been federated for a Single-Sign-On (SSO) on the first service and the at least one corresponding service, in order to make use of the known advantages of the SSO mechanism.

In response to receiving a request for a set of ratings data from a user, requesting for the first service on which the requesting user is federated for SSO, a group of users is identified amongst those users that are federated for SSO on the first and the at least one corresponding service for which ratings data is to be considered.

The respective SSO identity of each SSO federated user of the group of users is then mapped to one or more service identities of the respective SSO federated user, where each service identity is an identity that is associated with the first service or with a corresponding service. The described mapping process enriches the federation mechanism such that the ratings data of the first service and the ratings data of the at least one corresponding service will be bounded to the federation of the SSO identities.

Due to the mapping process, ratings data associated with the group of SSO users for the first service and the at least one corresponding service can then be collected from one or more databases. In order to be able to provide the collected ratings data to the requesting user in a unified format the collected ratings data is then normalized in accordance with pre-configured patterns, before the now normalized ratings data is transmitted to the requesting user.

The suggested method is suitable for collecting user generated ratings as well as predicted ratings, where the ratings may be either user based or item based.

The method may also be adapted such that it is triggered either by a user initiated, or by a service initiated request, i.e. a request that is automatically initiated by a service, e.g. on behalf of a user, that is executing a respective service.

The identifying step may include the step of retrieving a listing of a group of users that are associated with the requesting user, while the collecting step may comprise the further steps of identifying, on the basis of the mapping step, each service from which ratings data associated with a SSO federated user is to be considered, and of requesting admitted ratings data from each identified service.

The normalizing step may comprise the further step of requesting for a normalization of corresponding ratings data having different data types, where the normalization may e.g. be based on normalization templates that have been provided via the request, or from a database.

In order to enable a more selective collection of ratings data, the collecting step may comprise the further step of selecting ratings data on the basis of user knowledge of the requesting user and/or one or more of the users of the identified user group. In the present context such a user group may also be referred to as a neighborhood.

The suggested method makes it possible to obtain ratings data that may originate from various corresponding services, and that may have different data format, via one single sign on procedure, instead of having to successively sign on to the various services and having to manually combine the result provided from the different data sources.

According to another aspect an arrangement that is suitable for executing the suggested method is also provided. Such an arrangement may be provided with a processing unit that is configured to manage the steps described above in order to obtain normalized ratings data in a unified manner.

More specifically the processing unit may also be configured to execute any of the additional steps suggested above. The suggested arrangement is suitable to be implemented as an integrated part of a communication system, such as e.g. an IMS system, which thereby will be provided with facilities which enables users to obtain a more enriched result when requesting for ratings data associated with one or more rated items.

The suggested method enables a requesting user to share ratings obtained from different services, while maintaining control of how to obtain and process available ratings data.

### BRIEF DESCRIPTION OF THE DRAWINGS

The present invention is described by means of exemplary embodiments, and with reference to the accompanying drawings in which:

FIG. 1 is an illustration of a scenario for accessing a plurality of services, according to the prior art.

FIG. 2 is an illustration of another scenario for accessing services by making use of an SSO mechanism, according to the prior art.

FIG. 3 is an illustration of a scenario for accessing ratings data via an extended SSO mechanism that enables ratings data to be shared between different users in a unified way.

FIG. 4 is a flow chart, illustrating an SSO based procedure for enabling ratings data obtained from different services to be shared, according to one exemplary embodiment.

FIG. 5a is an exemplified mapping list, illustrating how SSO identities may be mapped to corresponding service identities.

FIGS. 5b and 5c are two exemplified listings of ratings given for two different services by users of a specific user group.

FIG. 6 is a system architecture, illustrating how an identity provider may be interconnected with a number of other functional entities, in order to collect and provide compatible ratings data to a requesting user.

FIG. 7a is a signaling scheme, illustrating how the method explained with reference to FIG. 3 may be applied in a system, such as the one described with reference to FIG. 6.

FIG. 7b is a signaling scheme, illustrating some optional steps that may be applied to the method described with reference to FIG. 7a.

FIG. 8 is a block diagram, schematically illustrating an arrangement that is configured to apply the method described with reference to FIG. 4, according to one exemplary embodiment.

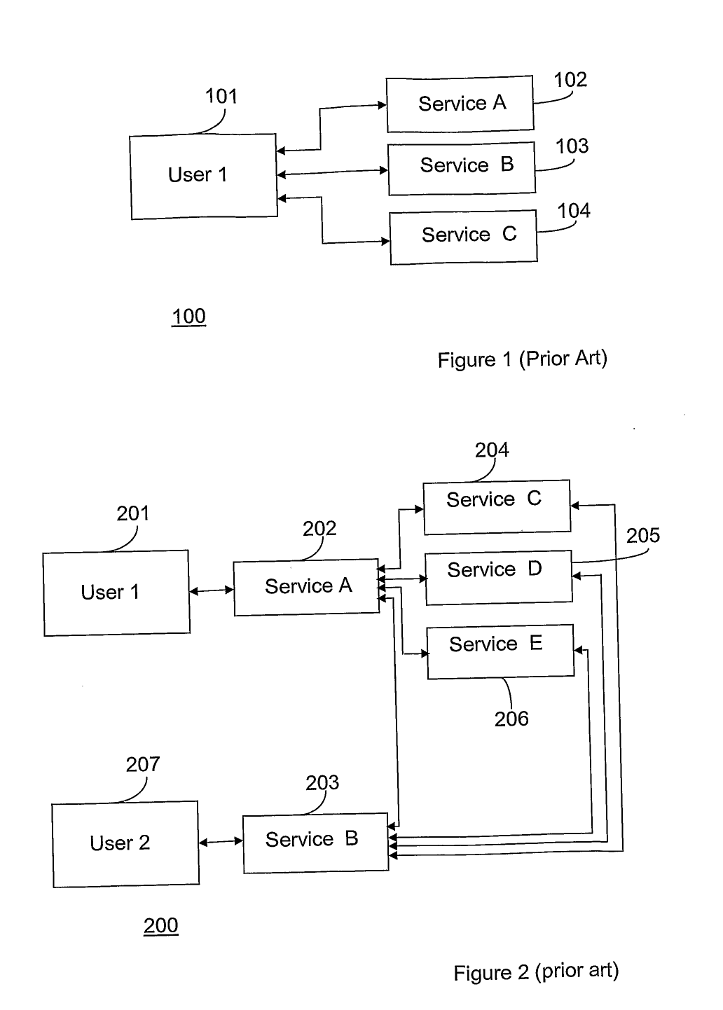

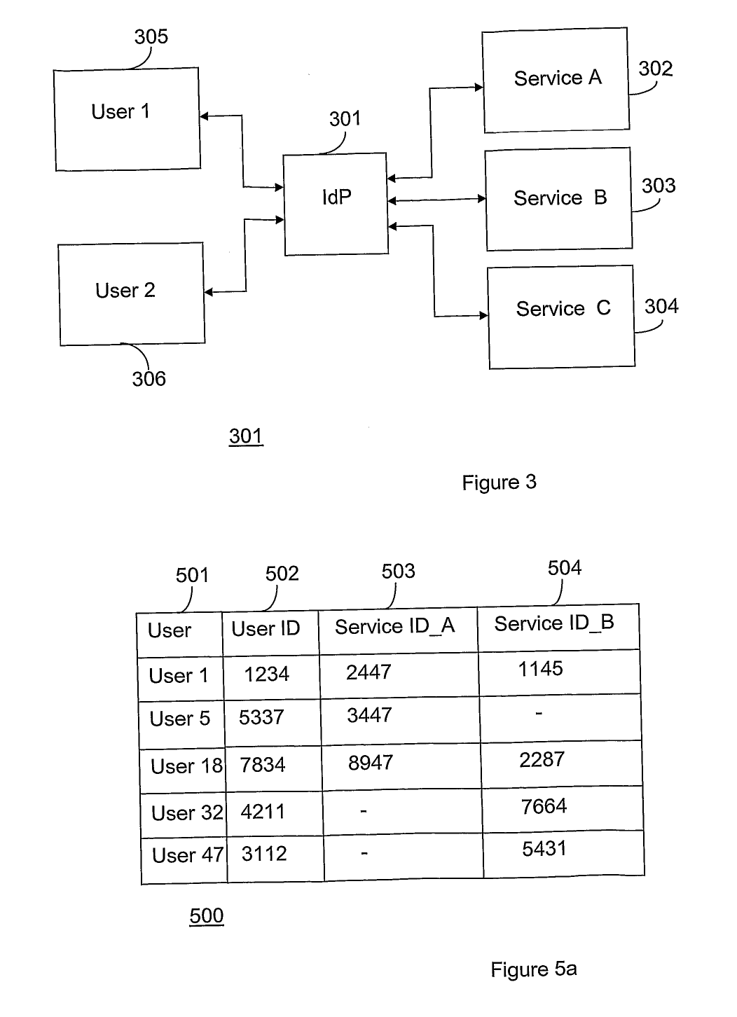

### DETAILED DESCRIPTION

Briefly described, the present invention relates to a method and an arrangement that is configured to allow ratings data provided from different services that offer rating possibilities to be shared and used in a generic way, and at a compatible format.

More specifically, a method and arrangement that is based on the known SSO mechanism is provided that enables a requesting user not only to apply a federated SSO log in, but also to initiate federation of ratings data, which may originally have been given in different formats to a plurality of services, such that this ratings data can be shared between the SSO federated users.

The suggested method and arrangement also enables normalization of ratings data, and, as well as of user generated ratings and system generated recommendations, which is based on federated ratings data.

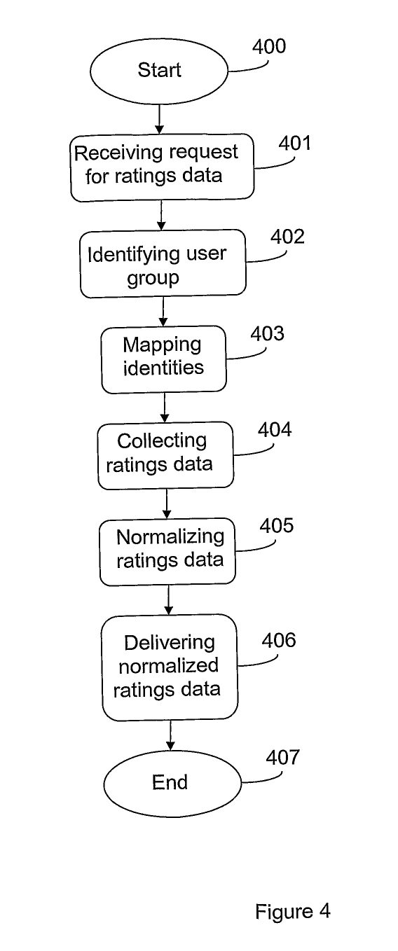

As illustrated with the scenario of FIG. 3, federation of ratings data may be achieved by introducing an arrangement, from hereinafter referred to as an identity provider (IdP) 301, that is configured to manage a procedure for collecting and processing ratings data, originating from different services, here exemplified with service A, B and C 302,303,304, respectively, typically provided by different service providers, such that compatible ratings data can be provided to any SSO federated requesting users, here represented by user 1 305 and user 2 306.

Irrespective, of which service any of SSO federated user 1 or user 2 chooses to log in to in order to access certain ratings data associated with some rated items, IdP 301 enables access also to ratings data given for the requested rated items in any of the other services.

From hereinafter services that are managed by the IdP 301 in such a manner will be referred to as corresponding services, since at least from the perspective of requesting ratings data, the different services corresponds to each other, even though ratings data obtained from different corresponding services may have different data format.

If for example SSO federated user 1 logs into a first service, service A 302, this user will have access to ratings data for items that have been rated via service A. However, due to the suggested federation mechanism, user 1, having requested for ratings data for one or more specific items will also be able to access all ratings data for the requested item/s that have been rated via any of services B 303 and C 304.

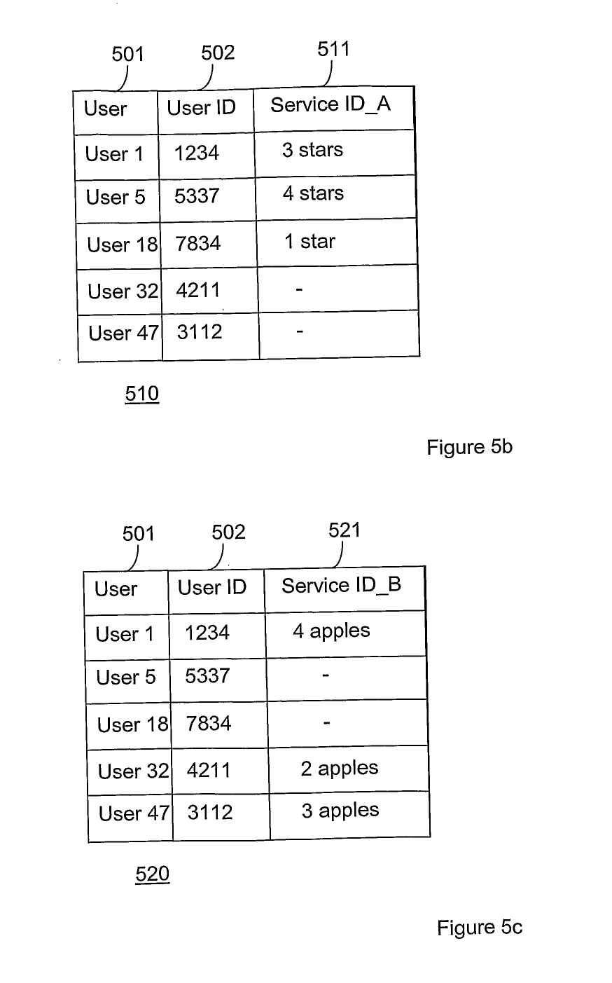

The general principles of the suggested federated ratings method will now be described in more detail with reference to the flow chart of FIG. 4. The method starting at a step 400 refers to a method of collecting ratings data that has been registered by a number of different users for two or more services, where each of these users is a user that has been federated for a SSO log-in on one or more of the available services.

In a step 401, a request for one or more ratings, in the present context also referred to as a set of ratings data, is received from a requesting user. In this context the requesting user may be a physical user, requesting a set of ratings via a user identity. Alternatively, the request may be initiated automatically by a service, such as e.g. a rating service or a recommending service that is requesting a set of ratings on behalf of a specific user.

In a typical scenario, item based ratings is applied, i.e. ratings for one or more specific attributes, or items that have previously been given by different users, is requested, e.g. by a recommending system, but the described system will also be applicable for user based ratings, where a set of ratings for different items, given by a specified user may be requested. Throughout this document the expression ratings, ratings data, or set of ratings data is therefore to be interpreted in its broadest sense to comprise user generated ratings and/or system generated recommendations.

In a next step 402, a group of users amongst the users that have been SSO federated for a plurality of services for which ratings data is to be considered is identified. The user group is typically defined according to the request, i.e. depending on what type of ratings data that is requested, and is provided as a list of users. If e.g. the most popular comedy films are requested, a user group comprising users that have rated comedy films via different film rating services is selected. This step typically comprises retrieving a group association of the requesting user, together with identities of the members of the group, including a user identity, here referred to as a SSO identity (SSO ID) and one or more service identities (service ID), each of which is used by the respective group member when exposing a specific service.

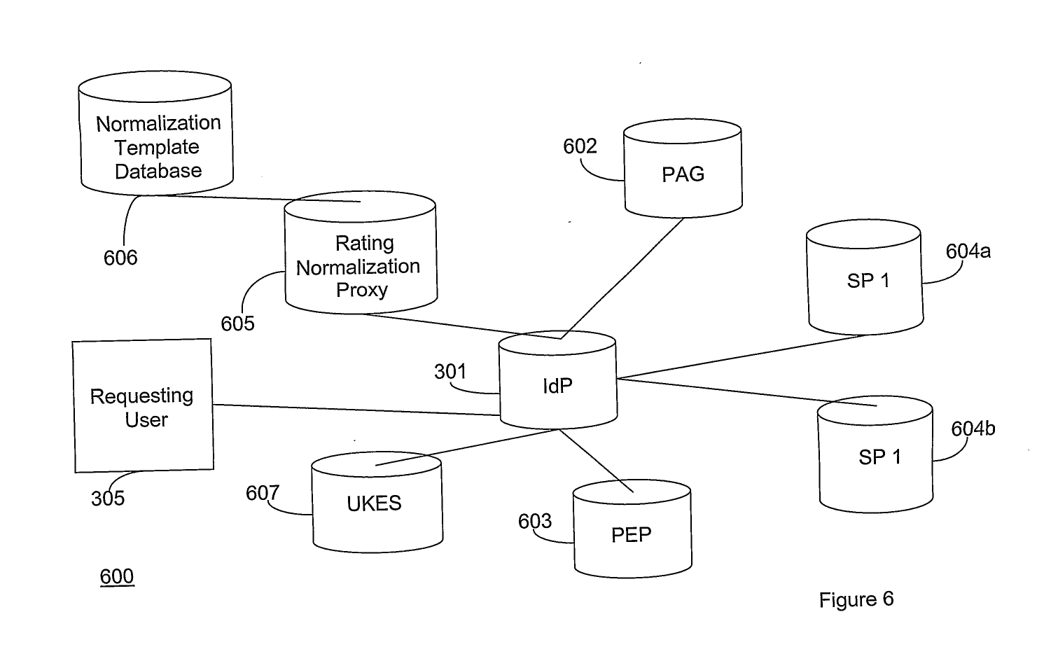

In a subsequent step 403, the respective SSO identity of each SSO federated user of the identified user group is mapped to one or more service identities, associated with the respective user. The result of such a mapping is represented by a list, which e.g. may have the format of the exemplified mapping list 500 of FIG. 5a, which comprise five different users listed in a user's column 501. Each group member/SSO federated user has an SSO ID stored in column 502, and for each federated service, a service ID is stored, as indicated in columns 503 and 504 respectively.

Although the exemplified list 500 only comprise two services, it is to be understood that an arbitrary number of services may have been mutually federated, and, thus, a typical mapping list may comprise a plurality of service ID's that are associated with a respective SSO ID, thereby enabling ratings data in all services for which a service ID can be mapped to be federated.

The purpose with such a mapping is to bind up the federation of attributes of various federated services, which in this context comprise ratings data, to the federation of the SSO identities, i.e. to enable for a requesting user to get access to ratings data from different services, by only having to log in to one single service.

If item based rating is applied, the SSO identity to service identity mapping may be anonymized. In such a case, instead of using the real identities of the respective users, a set of dummy identities may be applied which are then mapped to the actual service identity of a respective service.

Once the mapping of the previous step has been performed, relevant user federated ratings data associated with the users of the identified user group is collected from the service to which the user has logged in, as well as from one or more corresponding services, that are typically accessible via different SP's, as indicated with a next step 404.

Referring again to the user group of FIG. 5a, ratings data collected from a first service, service A, may e.g. have the form of the ratings in column 511 of FIG. 5b, where user 1, 5 and 18, have been given ratings for the requested item, e.g. a service, a sub-service, or one or more items, such as e.g. comedy films, that can be rated via a rating sub-service. FIG. 5c, illustrates a corresponding set of ratings, collected from service B, where ratings have been given in another data format.

Typically, ratings data collected from different services will have different data format and for that reason the collected ratings data is normalized. This is illustrated with another step 405, where in accordance with pre-configured patterns, which typically means that pre-defined normalization templates are used for obtaining the requested ratings data is transformed into a unified format. Such normalized templates may be retrieved e.g. from a database, or obtained already together with the request that was previously received in step 401.

After the ratings data has been normalized, or transformed, into one single data type, an appropriate presentation template is applied to the ratings data, such that an appropriate presentation format is created, before the resulting data is delivered to the requesting user, as indicated with a next step 406.

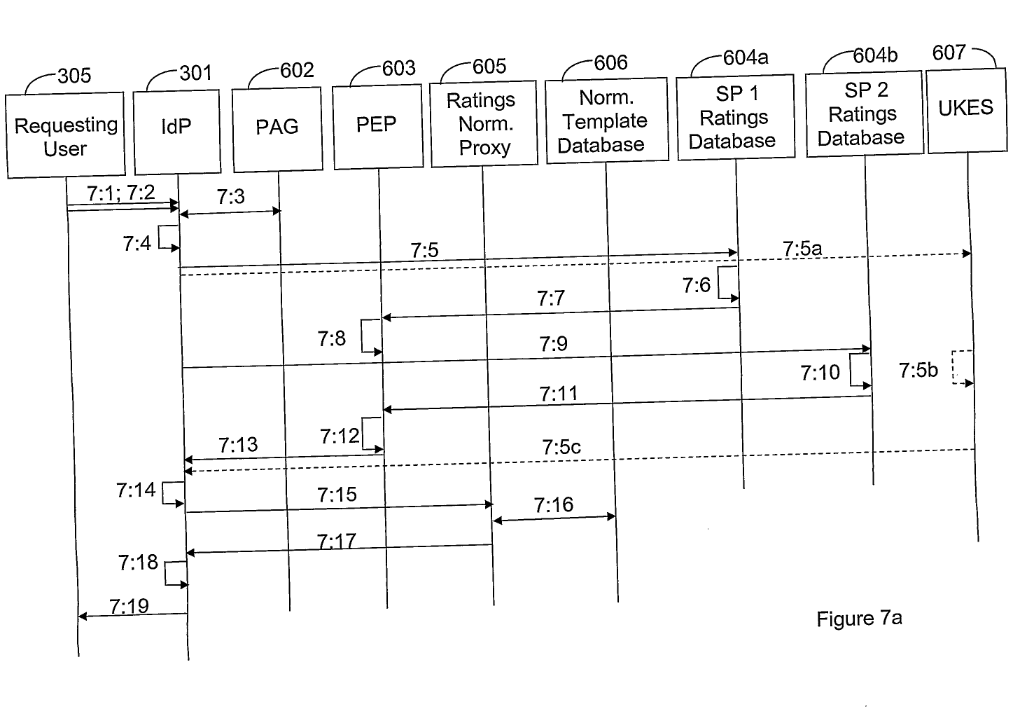

The method described above may be applied in a communications system, such as e.g. the simplified IMS system 600 of FIG. 6, which comprises an IdP 301, that has been configured to manage the suggested adapted federation mechanism in association with a number of additional functional entities. In particular, an IdP for a certain user may be an entity of a telecommunication network where said user holds a subscription.

In FIG. 6 IdP 301 is accessible to a plurality of SSO federated users, here represented by a single user, user 1 305, that may request a set of ratings data from IdP 301, e.g. via accessing a federated service by logging into the service via the amended SSO log in.

IdP 301 is configured to handle federation of identities and ratings in system 600. Such an identity federation is well known and may be managed according to a known SSO concept, such as e.g. the one defined in the Liberty Alliance specifications, that can be studied in more detail at “http:/www.projectliberty.org/resource_center/specifications/liberty_alliance_completed_specifications_zip_package_{—}22_june_{—}2008”.

The IdP 301 is configured to have a function as the intermediate application that federates ratings according to corresponding policies between a service provider of a specific service and recommendations, received from an external User Knowledge Extracting System (UKES) configured to retrieve relevant, accumulated knowledge about a requesting user, that may be used e.g. in association with selecting user group, and/or collecting ratings data from different ratings databases. A possible configuration of the IdP 301 will be described in more detail below. Alternatively UKES functionality may be integrated with the IdP 301.

According to another alternative configuration, a separate proxy (not shown) may have been dedicated to handle the described federation functionality.

A Presence and Group Management (PAG) node 602 is an IMS system node which is configured to handle group associations and presence information of different users.

A Policy Enforcement Point (PEP) 603 may be used for enforcing policies communicated to it, typically from a Policy Decision Point (PDP) (not shown).

FIG. 6 also comprise two Service Providers (SP), SP1 604a and SP2 604b, each of which are providing different services that may be accessed by the requesting users. Among other conventional functions an SP typically also comprise two databases, namely a Policy database, which allows the SP to act as a PDP, and a Ratings Database, which stores the ratings data.

The system 600 may also comprise a Rating Normalization Proxy 605 that is configured to assure that ratings data collected from different services is provided in a compatible format, by way of normalizing the ratings data. Rating Normalization Proxy 605 typically retrieves normalization templates from a Normalization Template Database 606. Apart from storing one or more different pre-defined normalization templates, such a database may also be configured to create a rule framework, e.g. on the basis of ontology, that is specifying how rated assets or items should be transformed between different asset domains.

As already mentioned above, a federated system may also comprise a UKES 607, which is a functional entity that is configured to use advanced machine learning methods on user data associated with a requesting user and/or a group member.

Such an entity may accumulate and extract user knowledge, i.e. knowledge about the user behavior, such as e.g. micro-segmentation information. If a recommendation service has been requested by a user, UKES 607 may provide this service to the IdP 301, which acts as a proxy towards UKES 607. UKES 607 may also be configured to find relevant items for which to retrieve ratings. Finally, a UKES may contain any type of conventional Machine Learning (ML) system, which may be used for progressively improving the recommendations based on feedback.

It is to be understood that although the system 600 of FIG. 6 comprises a specific set of functional entities, the IdP, as well as the other entities may be configured in a number of alternative ways, where certain optional functionality may be omitted, while other functionality may be distributed or integrated in a number of different configurations.

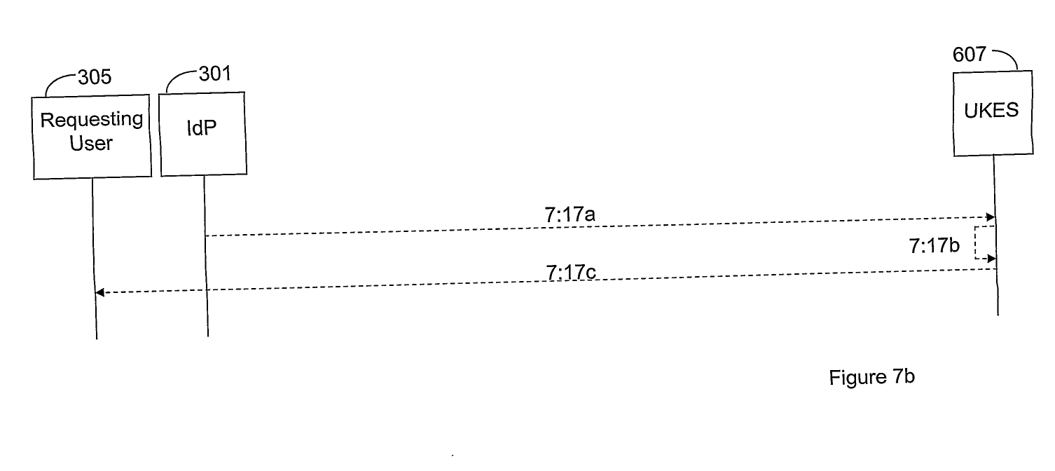

One way of executing the suggested federation mechanism on the basis of a system, such as the one described with reference to FIG. 6, will now be described in more detail below with reference to the signaling schemes of FIGS. 7a and 7b.

In a first step 7:1, an IdP 301 receives a request from a requesting user 305 to sign on to a specific service via a conventional SSO mechanism. As already mentioned above, the requesting user may be a user, requesting a set of ratings via the requesting entity. Alternatively, the request may be initiated automatically by a service, such as e.g. a recommending service, that is requesting a set of ratings on behalf of a specific user.

Once signed on, the requesting user 305 transmits a request for a set of ratings, i.e. ratings data or recommendations that are based on ratings data, to the IdP 301, as indicated with a subsequent step 7:2.

In a next step 7:3, IdP 301 associates the requesting user to a group of other users for which ratings data will later be retrieved. This step comprises a procedure for retrieving a group association of the requesting user 305, together with the identities of the members of the group. This step may typically be achieved by invoking a PAG 602, or another functional entity that provides corresponding functionality, i.e. to enabling identification of a user group.

In a subsequent step 7:4 IdP 301 uses a federation mechanism to map each SSO identity of each identified SSO federated group member to their respective service identity, i.e. the identity that the respective user is using for accessing a specific service. Such a mapping will bind the federation of attributes of various services, in this context ratings data, to the federation of the SSO identities.

Once the mapping of step 7:4 has been performed, IdP 301 requests user federated ratings data from relevant services, accessible from one or more SP's. In the present example, this is initially achieved in a step 7:5, where a ratings database of SP 1 604a is invoked.

In addition to requesting ratings data from SPs, the IdP 301 may also exploit accessible user knowledge about the requesting user 305 and/or the users of the user group. The user knowledge may later be used as additional information when determining for which specific items to receive ratings values from the different SPs. User knowledge may be obtained by invoking a UKES 607 system, or any other system or network node, having a corresponding functionality, i.e. that comprises some kind of Machine Learning (ML) System, and which has access to the relevant SP's. The ML of a UKES 607 may also be used for generating additional service groups, which may be used for subsequent requests.

In FIG. 7a a UKES 607 is invoked in an optional step 7:5a, which at this stage may be used for initiating user knowledge functionality that can be used when processing user generated ratings data, prior to providing a result of a request to the requesting user 305.

In a next step, expressed as step 7:6 in FIG. 7a, SP 1 604a retrieves policies, typically from a policy's database which is integrated with, or accessible from SP 1 604a, and which specifies under which conditions ratings data retrieved from SP 1 604a can be used, and ratings data associated with the request. Such policies may e.g. comprise an access control list which excludes ratings data of certain services, e.g. corresponding services provided from competing SPs, from being federated, while other policies may comprise regulations associated with specific users.

In a subsequent step 7:7 the retrieved policies and ratings data are transmitted to a node which is configured to enforce the relevant policies. In the present example such a policy enforcement process is indicated with a next step 7:8, and is executed by a PEP 603, but in an alternative system architecture, a corresponding PEP functionality may instead be integrated either in each SP, 604a, 604b, or centrally at the IdP 301.

The applicable policies may be pre-configured, specifying business-to-business (B2B) agreements, or Service Level Agreements (SLA), between the respective SP 604a, 604b and IdP 301, and/or agreements between a specific user and a SP. As a result of the latter case, policy enforcement of ratings data retrieved from a SP may result in a filtering that removes ratings data from a specified set of ratings data that a user does not want the requesting user to have access to. The agreements specifying the policies may be individual or generic, since they are all to be interworking with reference to the IdP 301, in order to obtain limitations to the federated ratings data.

In steps 7:9-7:12 a corresponding ratings data and policies retrieving process is performed for another SP, SP 2604b. It is to be understood that although only two SPs 604a, 604b are shown in FIG. 7a, a typical scenario may involve a plurality of additional SPs from which an IdP will request corresponding ratings data, according to the content of the request, in combination with the result from the previously executed mapping procedure, optionally, together with acquired user knowledge information.

In a step 7:13, the filtered ratings data obtained from the relevant corresponding services of SPs 604a,604b are transmitted to IdP 301, in the present example typically in an XML document, wherein information, such as e.g. name spaces and formats to be used when presenting the resulting ratings data may be aggregated in one single document.

If user knowledge was requested from UKES 607 in step 7:5a, such information will be processed by UKES 607, as indicated in process step 7:5b, and provided to IdP 301, as indicated in a subsequent step 7:5c.

The IdP 301 processes the retrieved ratings data, possibly, together with user knowledge data if such information was requested, by creating a ratings-to-user matrix, which comprises a listing of ratings data for one or more items or attributes associated with the users of the specified group. This is indicated with a step 7:14 in FIG. 7a.

In subsequent steps 7:15-7:17 IdP 301 requests for a normalization process to be performed on the ratings data retrieved originating from different services/SP's. As already mentioned, the normalization process will have the purpose of normalizing corresponding ratings data obtained from services for which ratings data have been given in different data formats. According to the present example the ratings-to-user matrix document is transmitted to a separate Ratings Normalization Proxy 605, as indicated with step 7:15. Ratings normalization Proxy 605 is configured to perform the required normalizations on the basis of relevant normalization templates, using any conventional normalization procedures.

The ratings normalization proxy 605 may access normalization templates by invoking a Normalization Template Database 606, as indicated with a step 7:16 in the present example. Alternatively, normalization templates may already have been provided to IdP 301 in the request, which was transmitted to IdP 301 in step 7:2, and, thus, in such a case the normalization templates are provided to the proxy 605 in the request forwarded in step 7:15. Which normalization templates to use in a respective situation may depend on different kinds of information, such as e.g. on name space and/or data type used in the ratings-to-user matrix document.

After the ratings data has been transformed into one single data type by the Ratings Normalization Proxy 605, an appropriate presentation template is applied to the ratings data, such that an appropriate presentation format is created. The result is transmitted to IdP 301 in a subsequent step 7:17 where the result may be further adapted, as indicated with a step 7:18, before the normalized ratings data is forwarded to the requesting entity 305, as indicated with a step 7:19, where the collected ratings data may be presented to a user, or used as input data, e.g. when performing collaborative filtering, which may be useful for executing correlations, ultimate recommendations, or any other type of calculation that is based on federated and normalized ratings data.

Alternatively, UKES functionality may be used for retrieving recommendations on the basis of the obtained normalized ratings data. Such an optional procedure may be exemplified as follows, referring to the signaling scheme of FIG. 7b, which is a continuation of the signaling executed in FIG. 7a.

An initiation of such an optional process is indicated with a step 5:17a, where the normalized ratings data is transmitted to a UKES 607, which may be the same entity as was described above, as indicated in the figure, or a separate UKES (not shown). The ratings data is processed by UKES 607 in a next step 7:17b, and transmitted to requesting user 305 in another step 7:17c, before the result is processed in step 7:18, according to FIG. 7a, and forwarded to requesting user 305 in the final step 7:19.

The suggested method enables sharing of rates and recommendations across different services/service providers in a unified and user-controlled fashion. This means that rates and recommendations can be made richer from the users perspective, than would have been the case if the ratings data was instead to be provided only from one services/service provider. Consequently also other entities that are making use of resulting ratings data may be provided with a richer input and, thus, will be able to provide an improved, ratings based, result.

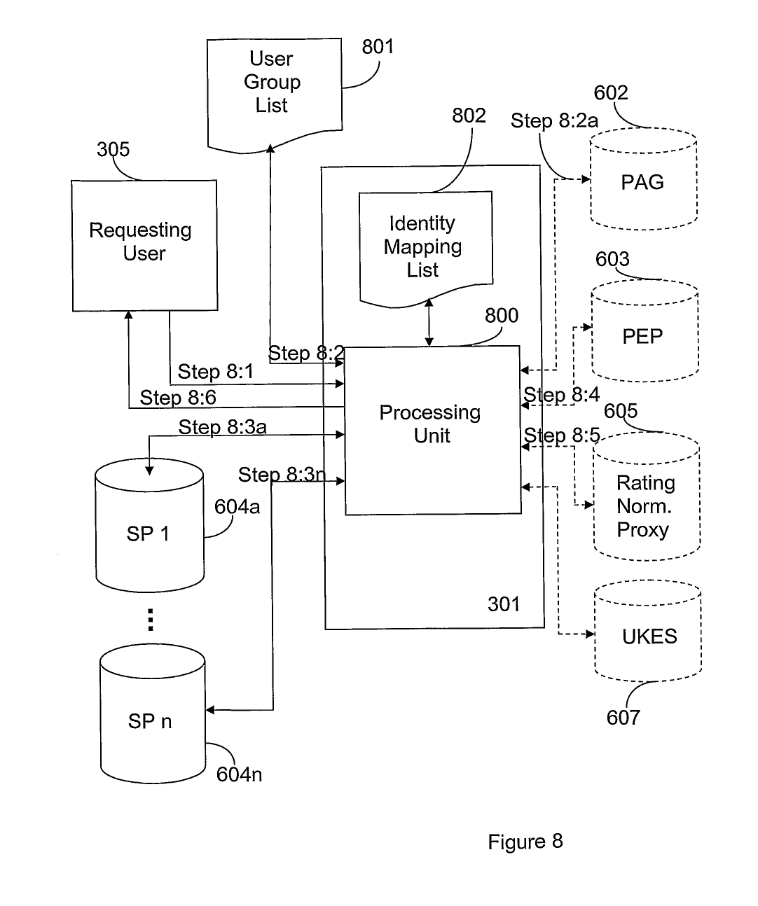

One exemplified configuration of an arrangement 301, which in the preceding examples has been referred to as an IdP, which is suitable for executing the method suggested above will now be described in more detail below, with reference to FIG. 8.

The arrangement 301 of FIG. 8 comprises a processing unit 800 that is configured to manage the suggested ratings federating mechanism. In response to receiving a request for a set of ratings, as indicated with step 8:1, the processing unit 800 is configured to initiate an identification of a group of users for which ratings data is to be considered, i.e. for which it is likely that corresponding federated ratings data will be accessible. In FIG. 8 the result of such a procedure is illustrated as user group list 801, and another step 8:2. According to one possible embodiment, he processing unit 800 may be configured to acquire such user group information from a PAG 602, as indicated with alternative step 8:2a.

Once a group of users has been identified, the processing unit 800 is configured to execute a mapping procedure, wherein the respective SSO identity of each SSO federated user of the group of users is mapped to one or more service identities of the respective SSO federated user, such that a federation of the ratings data of the first service and the at least one corresponding service is bounded to the federation of the SSO identities, and such that these federated ratings data will be accessible to the requesting user.

The processing unit 800 having initiated federation of the ratings data that may be of interest, is also configured to acquire relevant ratings data from different corresponding services, typically accessible via different SP's, here represented by SP 1 604a to SP n 604n, as indicated with steps 8:3a to step 8:3n. As already mentioned above, acquiring of ratings data may be achieved in association with a PEP 603, as indicate with a step 8:4, or any corresponding functionality, that is accessible to the processing unit 800. As has also already been mentioned above, different services/SP's may use different data format, and, thus, processing unit 800 having collected ratings data irrespective of the data format used, is therefore also configured to manage a normalization procedure, typically via an interaction with a ratings normalization function. In FIG. 8, this is indicated with processing unit 800 interacting with rating normalization proxy 605, via step 8:5. The processing unit is further configured to provide the requested, normalized ratings data to the requesting user 305, as indicated with step 8:6.

As indicated in the figure, processing unit 800 may also be configured to interact with one or more UKES 607 in order to enable e.g. personalization of the requests for ratings data. Alternatively, arrangement 301 may comprise such a system as an integrated system.

It is to be understood that the arrangement 301, described above is a simplified example of one possible configuration and system architecture, that is suitable for executing the suggested method for providing normalized ratings data to a requesting user, and that a number of alternative configurations are possible within the scope of what has been described in this document. One or more of the functional entities that are interconnected to the arrangement 301 of FIG. 8 may e.g. be configured as an integrated part of the arrangement 301, instead of being configured as a distributed, stand-alone entity.

It is also to be understood that a typical arrangement 301 will also comprise additional functionality that is commonly used for enabling the described type of communication, such as e.g. communication means and storage means. For simplicity reasons, such conventional functional means that are not necessary for the understanding of the specified way of handling ratings data has, however, been omitted. For the same reason, conventional functional entities such as e.g. a PEP, PAG, UKES which are considered to be used in a conventional way have only been described in general terms.

### ABBREVIATIONS

IdP Identity Provider

IMS Internet Multimedia Subsystem

PAG Presence and Group Management

PEP Policy Enforcement Point

SP Service Provider

SSO Single Sign On

UKES User Knowledge Extracting System

1. A method of collecting ratings data registered by a number of users for a first service and at least one corresponding service, wherein the users have been federated for a Single-Sign-On (SSO) on the first service and the at least one corresponding service, the method being characterized by:
receiving a request for a set of ratings data from a requesting user for the first service on which the requesting user is federated for SSO;
identifying a group of users amongst those users federated for SSO on the first and corresponding services for which ratings data is to be considered;
mapping the respective SSO identity of each SSO federated user of the group of users to one or more service identities of the respective SSO federated user, each service identity being an identity associated with the first service or with the at least one corresponding service, such that a federation of the ratings data of the first service and the at least one corresponding service is bounded to the federation of the SSO identities;
collecting ratings data associated with the SSO users of said group of SSO users for the first service and the at least one corresponding service;
normalizing said collected ratings data in accordance with pre-configured patterns, and
providing said normalized ratings data to said requesting user.

2. A method according to claim 1, wherein the ratings data comprises user generated ratings and/or predicted ratings.

3. A method according to claim 1, wherein the request is a request for user based ratings or item based ratings.

4. A method according to claim 1, wherein the request for a set of ratings data is a user initiated request or a service initiate request.

5. A method according to claim 1 wherein said identifying step further comprises the step of:
acquiring a listing of a group of users that are associated with the requesting user.

6. A method according to claim 1, wherein the collecting step further comprises the step of:
identifying, on the basis of the mapping step, each service from which ratings data associated with a SSO federated user is to be considered, and
requesting admitted ratings data from each identified service.

7. A method according to claim 1, wherein said normalizing step comprises the step of:
requesting for a normalization of corresponding ratings data having different data types.

8. A method according to claim 7, wherein said normalizing step is based on normalization templates that are provided via said request or from a database.

9. A method according to claim 1, wherein said collecting step further comprising the step of:
selecting ratings data on the basis of user knowledge of said requesting user and/or one or more of said users.

10. An arrangement for collecting ratings data that has been registered by a number of users for a first service and at least one corresponding service, wherein the users have been federated for a Single-Sign-On (SSO) on the first service and the at least one corresponding service in response to recognizing a request for a set of ratings data for the first service from a requesting user, the Identity Provider being characterized by:
a processing unit configured to manage:
identification of a group of users for which ratings data requested by a requesting user is to be considered;
mapping of a respective SSO identity of each SSO federated user of the group to its one or more service identities of the respective SSO federated user, each service identity being an identity associated with the first service or with a corresponding service, such that a federation of the ratings data of each service is bounded to the federation of the Single-Sign-On identities;
collection of ratings data associated with the SSO users of the group of SSO users for the first service and the at least one corresponding service;
normalization of the collected ratings data in accordance with pre-configured patterns, and
providing of the normalized ratings data to the requesting user.

11. An arrangement according to claim 10 wherein said processing unit is further configured to acquire a listing of the identified group of users, that are associated with the requesting user.

12. An arrangement according to claim 10, wherein the processing unit is further configured to execute the collecting step by identifying, on the basis of the mapping step, each service from which ratings data associated with a SSO federated user is to be considered, and by acquiring admitted ratings data from each identified service.

13. An arrangement according to claim 10, wherein said processing unit is further configured to execute the normalizing step by requesting for a normalization of corresponding ratings data having different data types.

14. An arrangement according to claim 10, wherein said processing unit is further configured to execute said collecting step by selecting ratings data on the basis of user knowledge of said requesting user and/or one or more of the users of the user group.

15. A communication system comprising an arrangement according to claim 10.

16. A communication system according to claim 15, wherein the communication system is an IMS system.
